(19) United States
(12) Patent Application Publication
(10) Pub. No.: US 2019/0005487 A1
(43) Pub. Date: Jan. 3, 2019

(54) METHOD AND SYSTEM FOR FACILITATING PAYMENT CARD BASED FINANCIAL TRANSACTIONS

(71) Applicant: Mastercard International Incorporated, Purchase, NY (US)

(72) Inventors: Nishant Maheshwari, Aligarh (IN); Abhishek Chaturvedi, Lucknow (IN); Sonali Jain, Pune (IN)

(73) Assignee: Mastercard International Incorporated, Purchase, NY (US)

(21) Appl. No.: 16/009,505

(22) Filed: Jun. 15, 2018

(30) Foreign Application Priority Data
Jun. 28, 2017 (SG) 10201705321S

(51) Int. Cl. G06Q 20/34; G06Q 20/40

(52) U.S. Cl. CPC G06Q 20/34; G06Q 20/4012

(57) ABSTRACT

A method and system for facilitating payment card based financial transactions are provided. A server system associated with a payment network receives an input provided by a user using an electronic device. The input is capable of uniquely identifying the user. The server system is configured to retrieve information related to one or more payment cards linked with the user if the user is successfully identified using the input. Subsequent to successful identification of the user, a prompt is displayed on the electronic device for seeking selection of a payment card for executing a financial transaction from the user. The server system receives a user selection of a payment card from among the one or more payment cards and facilitates processing of the financial transaction based on the user selection of the payment card.

### CROSS REFERENCE TO RELATED APPLICATIONS

This application claims priority to Singapore Application Serial No. 10201705321S, filed Jun. 28, 2017, which is incorporated herein by reference in its entirety

### TECHNICAL FIELD

The present disclosure relates to financial transactions, and more particularly to a method and system for facilitating payment card based financial transactions.

### BACKGROUND

Nowadays, most users use several banking cards, such as credit cards, debit cards, prepaid cards, etc. for performing financial transactions. The various banking cards are referred to herein as payment cards. The payment cards may be used for financial transactions, such as for making payment at a point-of-sale (POS) terminal, for making an online purchase transaction, or even for withdrawing currency from an Automated Teller Machine (ATM).

Typically, the users carry all the payment cards and use them selectively at various locations. For example, a user may use a particular card for purchasing a movie ticket, whereas the same user may use a different card for a dinner at a high-end restaurant. Carrying multiple payment cards is a concern for the user as the payment cards occupy a lot of space within a cardholder-case or a wallet and also add to the weight of the cardholder-case/wallet. Furthermore, carrying multiple payment cards at all times may also be a theft hazard. A stolen cardholder-case or a wallet may especially be a serious concern as the user may have to deactivate each payment card with the respective card issuing authority and thereafter reapply for each payment card, which may be cumbersome for the user.

Accordingly, there is a need to facilitate card based financial transactions, while precluding the users from carrying multiple payment cards. Moreover, there is a need to provide the user with the convenience of using any card issued to the user for performing a financial transaction, while precluding the user from carrying multiple payment cards.

### SUMMARY

Various embodiments of the present disclosure provide systems, methods, electronic devices and computer program products for facilitating payment card based financial transactions.

The method includes receiving, by a server system associated with a payment network, an input provided by a user using an electronic device. The input is capable of uniquely identifying the user. If the user is successfully identified at the server system using the input, the method includes retrieving information related to one or more payment cards linked with the user by the server system. Each payment card from among the one or more payment cards is capable of facilitating at least one financial transaction. The method includes receiving, by the server system, a user selection of a payment card from among the one or more payment cards for executing a financial transaction. The user selection is provided by the user in response to a prompt displayed on the electronic device for seeking selection of a payment card from the user. The prompt is displayed subsequent to successful identification of the user. The method further includes facilitating, by the server system, processing of the financial transaction based on the user selection of the payment card.

A server system associated with a payment network includes a database and a computer system. The database is configured to store a plurality of user accounts. Each user account includes information related to user input capable of uniquely identifying respective user, and information related to one or more payment cards associated with the respective user. Each payment card from among the one or more payment cards is capable of facilitating at least one financial transaction. The computer system is in operative communication with the database and includes a communication interface and a processor. The communication interface is configured to receive an input provided by a user. The input is provisioned by the user using an electronic device for initiating a financial transaction. The input is capable of uniquely identifying the user. The processor is in operative communication with the communication interface and configured to compare the input provided by the user with stored information corresponding to the plurality of user accounts to identify the user. If the user is successfully identified using the input, the processor is configured to retrieve information related to one or more payment cards linked with the user. The processor is configured to receive a user selection of a payment card from among the one or more payment cards for executing the financial transaction. The user selection is provided by the user in response to a prompt displayed on the electronic device for seeking selection of a payment card from the user. The prompt is displayed subsequent to successful identification of the user. The processor is configured to facilitate processing of the financial transaction based on the user selection of the payment card.

An electronic device includes a display module, an input module and a communication module. The display module is capable of displaying a first UI showing a prompt to a user to provide an input. The input module is configured to receive an input provided by the user. The input is capable of uniquely identifying the user. The communication module is in operative communication with a server system associated with a payment network and is configured to provision the input to the server system. The display module is configured to display a second UI showing a prompt for seeking selection of a payment card from among one or more payment cards linked with the user. The second UI showing the prompt is displayed subsequent to successful identification of the user at the server system. The input module is configured to receive a user selection of a payment card from among the one or more payment cards, and the communication module is configured to provision the user selection to the server system to facilitate processing of a financial transaction based on the user selection of the payment card.

A computer program product includes at least one computer-readable storage medium. The computer-readable storage medium includes a set of instructions which, when executed by one or more processors, cause a computing device to receive an input provided by a user using an electronic device. The input is capable of uniquely identifying the user. If the user is successfully identified using the input, the computing device is configured to retrieve information related to one or more payment cards linked with the user. Each payment card from among the one or more payment cards is capable of facilitating at least one financial transaction. The computing device is configured to receive a user selection of a payment card from among the one or more payment cards for executing a financial transaction. The user selection is provided by the user in response to a prompt displayed on the electronic device for seeking selection of a payment card from the user. The prompt is displayed subsequent to successful identification of the user. The computing device is configured to facilitate processing of the financial transaction based on the user selection of the payment card.

### BRIEF DESCRIPTION OF THE FIGURES

For a more complete understanding of example embodiments of the present technology, reference is now made to the following descriptions taken in connection with the accompanying drawings in which:

FIG. 1 is a schematic diagram illustrating an exemplary multi-party payment card system for enabling payment-by-card transactions in which merchants and card issuers do not necessarily have a one-to-one relationship;

FIG. 2 is a simplified block diagram of an exemplary payment network, in accordance with one embodiment of the present invention;

FIG. 3 is a simplified block diagram of the server system of FIG. 2, in accordance with one embodiment of the present invention;

FIG. 4 illustrates an exemplary configuration of an electronic device, in accordance with one embodiment of the invention;

FIG. 5 is a simplified representation of a UI facilitating mapping of payment cards to a user account created on the payment network of FIG. 2, in accordance with one embodiment of the present invention;

FIG. 6 is a simplified representation of a UI facilitating association of user biometric information with a user account created on the payment network of FIG. 2, in accordance with one embodiment of the present invention;

FIG. 7 is a schematic representation of a user account linked to multiple payment cards, in accordance with one embodiment of the present invention;

FIG. 8 is a simplified representation of a format for storing payment card information related to several user accounts, in accordance with one embodiment of the present invention;

FIG. 9 is a simplified representation of a first UI presented to a user for initiating a financial transaction, in accordance with one embodiment of the present invention;

FIG. 10 is a simplified representation of a second UI displaying a prompt to the user to select a payment card for executing the financial transaction, in accordance with one embodiment of the present invention;

FIG. 11 is a simplified representation of a second UI displaying a prompt to the user to select a payment card for executing the financial transaction, in accordance with another embodiment of the present invention;

FIG. 12 is a simplified representation of a second UI displaying a prompt to the user to select a payment card for executing the financial transaction, in accordance with yet another embodiment of the present invention;

FIG. 13 is a simplified representation of an example process flow for issuing a universal payment card to a user, in accordance with one embodiment of the present invention;

FIG. 14 is a simplified representation of an example process flow for executing a financial transaction using the universal payment card, in accordance with one embodiment of the present invention;

FIG. 15 is a flowchart illustrating a method for facilitating a payment card based financial transaction, in accordance with one embodiment of the present invention;

FIG. 16 is a flowchart illustrating a method for facilitating a payment card based financial transaction, in accordance with another embodiment of the present invention; and

FIG. 17 is a flow diagram illustrating a method for facilitating a financial transaction using a payment card, in accordance with yet another embodiment of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Overview

Users typically use a variety of banking cards, such as credit cards, debit cards, etc. to perform financial transactions. Some examples of financial transactions include making payments at point-of-sale (POS) terminals in merchant sites, making online payments using payment gateways associated with enterprise Websites, withdrawing currency from automated teller machine (ATM) kiosks, and the like. Typically, the users carry all the payment cards and use them selectively at various locations. Carrying multiple banking cards is a concern for the user as these cards (also referred to herein as payment cards) occupy a lot of space within a cardholder-case or a wallet and also add to the weight of the cardholder-case/wallet. Furthermore, carrying multiple payment cards at all times may also be a theft hazard.

Various embodiments of the present invention provide methods, systems, electronic devices and computer program products for overcoming the above drawbacks and providing additional advantages. More specifically, various embodiments as disclosed herein facilitate payment card based financial transactions, while precluding the users from carrying multiple payment cards. The techniques disclosed herein provide the user with the convenience of using any card issued to the user for performing a financial transaction without having to carry multiple payment cards.

In one embodiment, a payment card system interchange network (hereinafter referred to as payment network), such as the MasterCard® interchange network enables a user to create a user account with the payment network. Further, the payment network enables the user to map (or link) one or more banking cards, like debit cards, credit cards, etc. (collectively referred to as payment cards) with the user account. The payment network also enables the user to link a biometric input, which is capable of uniquely identifying the user, with the user account. In some embodiments, the user may also store a unique identification number with the user account. Furthermore, the user may also assign a priority rank to each payment card in the user account.

Thereafter, when performing a financial transaction using an electronic device, the user first provides a biometric input to authenticate a personal identity. Some non-exhaustive examples of the electronic device may include a personal computing device associated with the user, an automated teller machine (ATM), a point-of-sale (POS) terminal at a merchant site, and the like. The biometric input provided by the user using the electronic device is received by the payment network. The payment network is configured to compare the biometric input with stored user account records to identify the user. Subsequent to the successful identification of the user, the payment network is configured to retrieve one or more payment cards linked with the user account. The payment network is further configured to cause display of a prompt on the electronic device to facilitate selection of a payment card for a current transaction.

In one embodiment, the user may provide the priority rank of the payment card to be used for the financial transaction and a PIN associated with the payment card to provide the user selection of a payment card. In an illustrative example, a user may have three payments cards linked with the user account at the payment network. The cards may be associated with priority ranks ‘1’, ‘2’ and ‘3’ and the PIN associated with the three cards may be ‘1234’, ‘5678’ and ‘7812’, respectively. If the user intends to use the third payment card for a current financial transaction at a merchant site, then the user may provide an input ‘37812’ (i.e. a combination of the priority rank of the third payment card and the PIN associated with that card) to indicate selection of the third payment card from among the three cards for the current financial transaction. The payment network may receive the selection of the third payment card and thereafter facilitate processing of the financial transaction using the third payment card.

In one embodiment, subsequent to successful identification of the user based on the biometric input, the payment network may cause display of images of the payment cards linked with the user account on a display screen of the electronic device. The user may then provide a click or a touch input on an image of a payment card to provide selection of a payment card. The payment network may receive the selection of the payment card and thereafter facilitate processing of the financial transaction using the selected payment card.

In one embodiment, subsequent to successful identification of the user based on the biometric input, the payment network may cause display of details of the payment cards linked with the user account in an encrypted form. For example, the payment network may cause display of a string of characters for each payment card linked with the user account on a display screen of the electronic device. For example, if the user account is linked with a Citibank® credit card, a Citibank® debit card and an American Express® corporate card, then the payment network may cause display of string of characters for these cards as ‘CITI C’, ‘CITI D’ and ‘AMEX C’ on the display screen of the electronic device. The user may then provide a click or a touch input on a string of characters of a payment card to provide selection of a payment card. The payment network may receive the selection of the payment card and thereafter facilitate processing of the financial transaction using the selected payment card.

As explained above, the linking of payment cards to a biometric input may enable the user to select any payment card for performing a financial transaction, without having to physically carry multiple payment cards.

In one embodiment, the payment network may also facilitate provisioning of a universal payment card to a user. In an illustrative example, a user may request a card issuing authority to issue a payment card, such as a debit card or a credit card. The card issuing authority may communicate such a request to the payment network. The payment network may check if the user has been previously issued a universal payment card and if not, the payment network may be caused to issue, i.e. print and post, a universal payment card to the user. The universal payment card may be associated with a unique universal payment card number. The payment network may communicate the details of the universal payment card, such as the universal payment card number, expiry date, card verification value (CVV) number etc. to the card issuing authority. The card issuing authority may generate a payment card (i.e. a banking card bearing their brand/logo) for the user and link the card to the universal payment card. The user may be emailed the details of the payment card issued by the card issuing authority. It is noted that the card issuing authority does not print and post the payment card generated by them to the user. The user is issued only the universal payment card and only the universal payment card is posted to the user. Thereafter, any payment card issued by any card issuing authority may similarly be linked to the universal payment card. As explained above, only one payment card, i.e. the universal payment card, is shipped to the user and that too, only once. The user may use the universal payment card to retrieve all linked payment cards to perform financial transactions. The user in such a case may need to carry only one payment card or in some cases only remember the universal payment card number to perform financial transactions. The user is thus relieved from carrying multiple payment cards while still being able to use any payment card for performing financial transactions.

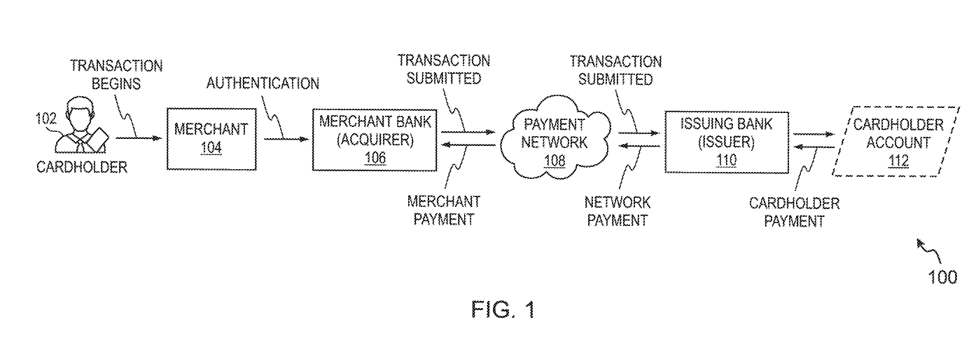

FIG. 1 is a schematic diagram illustrating an exemplary multi-party payment card system 100 for enabling payment-by-card transactions in which merchants and card issuers do not necessarily have a one-to-one relationship. The present invention relates to payment card system 100, such as a credit card payment system using a payment card system interchange network 108 such as the MasterCard® payment card system interchange network. MasterCard® payment card system interchange network is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.). The payment card system interchange network 108 is hereinafter referred to as payment network 108.

In payment card system 100, a financial institution such as an issuer 110 issues a payment account card, such as a credit card account or a debit card account, to a cardholder 102, who uses the payment account card to tender payment for a purchase from a merchant 104. To accept payment with the payment account card, the merchant 104 must normally establish an account with a financial institution that is part of the financial payment system. This financial institution is usually called the “merchant bank” or the “acquiring bank” or “acquirer bank” or simply “acquirer”. When a cardholder 102 tenders payment for a purchase with a payment account card (also known as a financial transaction card), merchant 104 requests authorization from acquirer 106 for the amount of the purchase. The request may be performed over the telephone, but is usually performed through the use of a point-of-sale (POS) terminal, which reads the cardholder's account information from the magnetic stripe on the payment account card and communicates electronically with the transaction processing computers of acquirer 106. Alternatively, acquirer 106 may authorize a third party to perform transaction processing on its behalf. In this case, the point-of-sale terminal will be configured to communicate with the third party. Such a third party is usually called a “merchant processor” or an “acquiring processor.”

Using payment network 108, the computers of acquirer 106 or the merchant processor will communicate with the computers of issuer 110 to determine whether the cardholder's account is in good standing and whether the purchase is covered by the cardholder's available credit line or account balance. Based on these determinations, the request for authorization will be declined or accepted. If the request is accepted, an authorization code is issued to merchant 104.

When a request for authorization is accepted, the available credit line or available balance of cardholder's account 112 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 104 captures the transaction by, for example, appropriate data entry procedures on the point-of-sale terminal. If a cardholder cancels a transaction before it is captured, a “void” is generated. If a cardholder returns goods after the transaction has been captured, a “credit” is generated.

For debit card transactions, when a request for a PIN authorization is approved by the issuer 110, the cardholder's account 112 is decreased. Normally, a charge is posted immediately to cardholder's account 112. The bankcard association then transmits the approval to the acquiring processor for distribution of goods/services, or information or cash in the case of an ATM.

After a transaction is captured, the transaction is settled between merchant 104, acquirer 106, and issuer 110. Settlement refers to the transfer of financial data or funds between the merchant's account, acquirer 106, and issuer 110 related to the transaction. Usually, transactions are captured and accumulated into a “batch,” which is settled as a group.

Financial transaction cards or payment account cards refer to cards used as a method for payment for performing transactions. As described herein, the term “financial transaction card” or “payment account card” includes cards such as credit cards, debit cards, and prepaid cards, but also includes any other devices that may hold payment account information, such as mobile phones, personal digital assistants (PDAs), and key fobs. Financial transaction cards or payment account cards are hereinafter referred to as “payment cards”. The transactions performed using the payment cards are referred to as “payment card transactions” or “financial transactions”. An example of a financial transaction may include making payment using the payment card at a merchant site. Another example of a financial transaction may include withdrawal of currency from an automated teller machine (ATM). Yet another example of a financial transaction may include online payment for purchase of a product or a service.

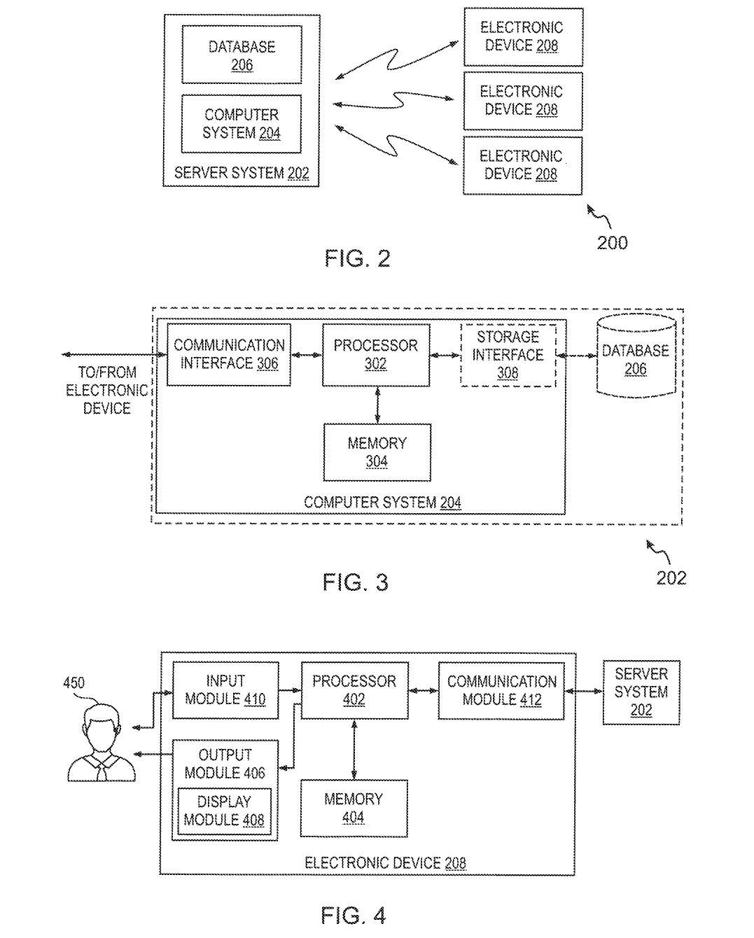

FIG. 2 is a simplified block diagram of an exemplary payment network 200 such as the payment network 108 of FIG. 1, in accordance with one embodiment of the present invention. The payment network 200 is configured to facilitate payment card based financial transactions as explained with reference to FIG. 1.

The payment network 200 includes a server system 202 comprising a computer system 204 and a database 206. The payment network 200 also depicts a plurality of electronic devices 208 in operative communication with the server system 202. The electronic devices 208 may be interconnected to the Internet through many interfaces including a network, such as a local area network (LAN) or a wide area network (WAN), dial-in-connections, cable modems, and special high-speed ISDN lines.

In one embodiment, one of electronic devices 208 may correspond to a personal computing device of a user associated with one or more payment cards. Some non-exhaustive examples of the personal computing device may include a smartphone, a laptop, a desktop, a workstation terminal, a wearable device, a tablet computer, a personal digital assistant (PDA), and the like.

In one embodiment, one of electronic devices 208 may be associated with an acquirer while another one of electronic devices 208 may be associated with an issuer.

In one embodiment, one of electronic devices 208 may correspond to a point-of-sale (POS) terminal, such as for example a payment card reader, at a merchant site. The POS terminal may be configured to be in operative communication with a computer at the merchant bank (i.e. the acquirer), which may in turn be in operative communication with the server system 202.

In one embodiment, one of electronic devices 208 may correspond to an automated teller machine (ATM). The ATM may be configured to be in operative communication with a computer at a corresponding bank (i.e. with the acquirer), which may in turn be in operative communication with the server system 202. The server system 202 is explained in further detail with reference to FIG. 3.

FIG. 3 is a simplified block diagram of the server system 202 of FIG. 2, in accordance with one embodiment of the present invention. As explained above, the server system 202 is a part of the payment network 200. The server system 202 includes the computer system 204 and the database 206.

The computer system 204 includes a processor 302 for executing instructions. Instructions may be stored in, for example, but not limited to, a memory 304. Processor 302 may include one or more processing units (e.g., in a multi-core configuration).

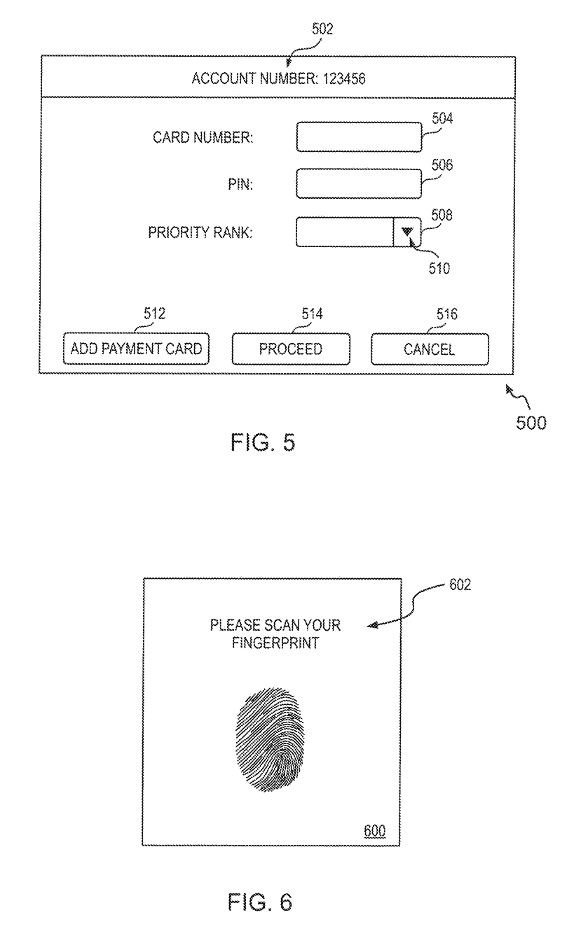

The processor 302 is operatively coupled to a communication interface 306 such that computer system 204 is capable of communicating with a remote device such as an electronic device 208 (shown in FIG. 2). For example, the communication interface 306 may receive requests from an electronic device 208 associated with a cardholder, via the Internet, for creating a user account or for performing a payment card based financial transaction, as will be explained later with reference to FIGS. 5 to 14.

The processor 302 may also be operatively coupled to the database 206. The database 206 is any computer-operated hardware suitable for storing and/or retrieving data, such as, but not limited to, transaction data generated as part of sales activities conducted over the bankcard network including data relating to merchants, account holders or customers, and purchases. The database 206 may also store information related to a plurality of user accounts. Each user account data includes at least one of a cardholder name, a cardholder address, an account number, and other account identifiers. The database 206 may also store merchant data including a merchant identifier that identifies each merchant registered to use the payment network 200, and instructions for settling transactions including merchant bank account information. The database 206 may include multiple storage units such as hard disks and/or solid-state disks in a redundant array of inexpensive disks (RAID) configuration. The database 206 may include a storage area network (SAN) and/or a network attached storage (NAS) system.

In some embodiments, the database 206 is integrated within computer system 204. For example, computer system 204 may include one or more hard disk drives as database 206. In other embodiments, database 206 is external to computer system 204 and may be accessed by the computer system 204 using a storage interface 308. The storage interface 308 is any component capable of providing processor 302 with access to the database 206. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to the database 206.

FIG. 4 illustrates an exemplary configuration of an electronic device 208, in accordance with one embodiment of the invention. The electronic device 208 may correspond to a personal computing device of a consumer, a computing device associated with an acquirer or an issuer, an ATM, a POS terminal, and the like.

The electronic device 208 includes a processor 402 for executing instructions. In some embodiments, executable instructions are stored in a memory 404. The processor 402 may include one or more processing units (e.g., in a multi-core configuration). The memory 404 is any device allowing information such as executable instructions and/or transaction data to be stored and retrieved. The memory 404 may include one or more computer readable media.

The electronic device 208 also includes an output module 406 for presenting information to a user 450. The output module 406 is any component capable of conveying information to the user 450. In some embodiments, output module 406 includes an output adapter (not shown) such as a video adapter and/or an audio adapter. An output adapter is operatively coupled to the processor 402 and operatively couplable to an output device such as a display module 408 (e.g., a cathode ray tube (CRT), liquid crystal display (LCD), light emitting diode (LED) display, or “electronic ink” display) or an audio output device (e.g., a speaker or headphones). In some embodiments, display module 408 is configured to present a graphical user interface (e.g., a web browser and/or a client application) to the user 450. A graphical user interface may include, for example, an online store interface for viewing and/or purchasing items, a wallet application for managing payment information, and/or an ATM interface for withdrawing currency from an ATM.

In some embodiments, electronic device 208 includes an input module 410 for receiving input from the user 450. The user 450 may use input module 410 to select and/or enter, without limitation, one or more items to purchase, a purchase request, access credential information, and/or payment information. In some embodiments, the user 450 may use the input module 410 to create a user account at the payment network 200, to provide a biometric input, to provide a selection of a payment card for a financial transaction, and the like. The input module 410 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both the display module 408 of the output module 406 and the input module 410.

The electronic device 208 may also include a communication module 412, which is communicatively couplable to a remote device such as the server system 202 (explained with reference to FIG. 3). The electronic device 208, using the communication module 412, may be interconnected to the Internet through many interfaces including a network, such as a local area network (LAN) or a wide area network (WAN), dial-in-connections, cable modems, and special high-speed ISDN lines. The communication module 412 may include, for example, a wired or wireless network adapter and/or a wireless data transceiver for use with a mobile telecommunications network.

Stored in memory 404 are, for example, computer readable instructions for providing a user interface (UI) to the user 450 via the display module 408 and, optionally, receiving and processing input from the input module 410. A UI may include, among other possibilities, a Web browser and/or a client application. Web browsers enable users, such as the user 450, to display and interact with media and other information typically embedded on a Web page or a Website from the server system 202. A client application allows the user 450 to interact with a server application of a merchant computer system, POS terminals, and/or the server system 202.

In at least some embodiments, the user 450 may use an electronic device 208 embodied as a personal computing device to create a user account with the payment network 200. More specifically, the user 450 may access the computer system 204 associated with the payment network 200 to create a user account. As explained above, the electronic device 208 includes a communication module 412 capable of interconnecting the electronic device 208 to the Internet. The user 450 may use the electronic device 208 to connect to the Internet and access a Web-based UI associated with the computer system 204. The computer system 204 of the server system 202 is also interconnected to the Internet using the communication interface 306 (depicted in FIG. 3). In one embodiment, the Web-based UI may correspond to a Website associated with the payment network 200. The user 450 may provide personal information, such as name, address, email ID, phone number and such other details for creation of the user account. In one embodiment, the user 450 may also provide a number, such as social security number or a personal account number (PAN) assigned to the user by a governmental agency to uniquely identify the user. Such a number may be stored as a unique identification number in the database 206 as part of the user account information.

In one embodiment, subsequent to the creation of the account, the user 450 may map one or more payment cards with the user account. In one embodiment, the user may also associate biometric information, such as fingerprint scan or an iris scan, with the user account. Example UIs provided by the computer system 204 for facilitating mapping of the one or more payment cards and the association of the biometric information to the user account are depicted in FIGS. 5 and 6, respectively.

FIG. 5 is a simplified representation of a UI 500 facilitating mapping of payment cards to a user account created on the payment network 200 (shown in FIG. 2), in accordance with one embodiment of the present invention. The UI 500 depicts a header portion 502 displaying a user account number (exemplarily depicted to be 123456). The UI 500 further depicts a plurality of form fields, such as form fields 504, 506 and 508, capable of receiving user input related to payment card to be added, a PIN number associated with the card and a priority rank to be assigned to the card, respectively.

In one embodiment, the form field 504 is capable of receiving a 16-digit numerical input corresponding to the number of the payment card. In one embodiment, the form field 504 may be capable of receiving input in form of ‘XXXX-XXXX-XXXX-XXXX’, where ‘X’ corresponds to a positive integer. The user may sequentially input the digits of the payment card number and the form field 504 may be configured to align the numbers in the form, depicted above. In one embodiment, the UI 500 may also include another form field requesting the user to reconfirm the payment card number. The processor 302 of the computer system 204 may be configured to compare the entries in the two form fields for receiving the payment card number and flag an error if the numbers do not match.

The form field 506 is configured to receive an input corresponding to the personal identification number or PIN. The issuer of the payment card typically assigns a PIN to the user as a security measure for authenticating a personal identity during financial transactions. In some example scenarios, the user may wish to change the PIN number and accordingly, select a different PIN and register the new PIN with the issuer of the payment card. In one embodiment, the user may provide a four-digit entry corresponding to the PIN for the payment card in the form field 506.

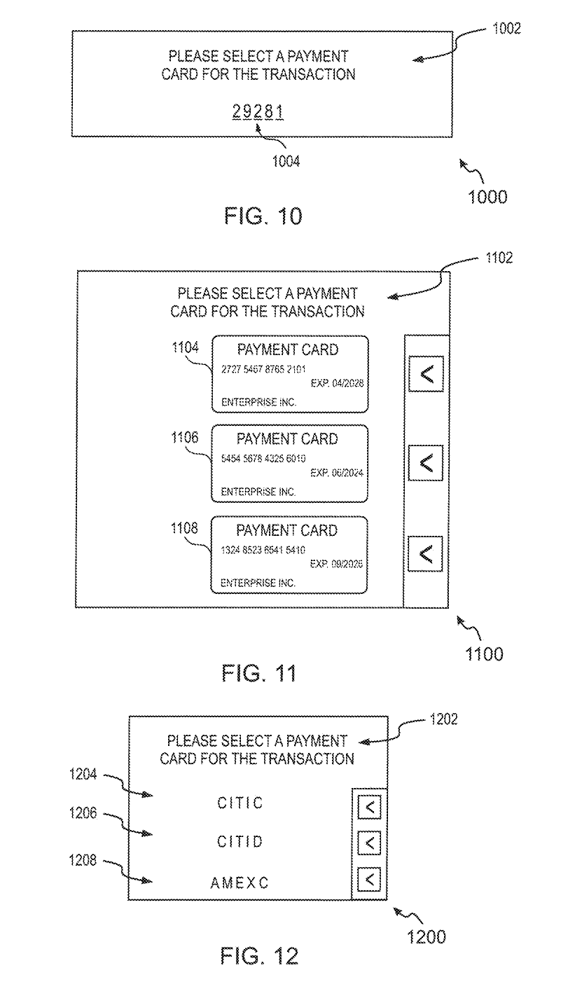

The form field 508 is configured to receive an input corresponding to a priority rank of the payment card. The user may assign a priority rank for each payment card. The priority rank may facilitate selection of a payment card for a current financial transaction as will be explained later with reference to FIG. 10. The form field 508 is depicted to be associated with a selectable button 510. The selectable button 510, upon selection, is capable of displaying a drop-down list of numbers from 1 to 9. The user may select a number from the displayed list to assign a priority rank for the payment card. In one embodiment, the form field 510 may preclude a drop-down list and instead the user may enter a numerical input to provide a priority rank for the payment card.

The UI 500 further depicts three buttons 512, 514 and 516 displaying text ‘Add payment card’, ‘Proceed’ and ‘Cancel’, respectively. The user may select the button 516 to cancel mapping of the payment card to the user account. The user may select the button 512 to map another payment card with the user account. The user selection of the button 512 may cause display of another UI, such as the UI 500, using which the user can add the payment card number of a different payment card along with a corresponding PIN, and assign a different priority rank to that payment card to map the payment card to the user account. It is noted that processor 302 may be configured to add/map a payment card to the user account only subsequent to successful verification of the user as the cardholder. To that effect, the processor 302 may be configured to send a verification code to user's email ID or phone number registered with the issuer of the payment card. The user may be requested to enter the same verification code in a pop-up on the UI 500 to complete the verification of the user. It is noted that other forms of verification, such as answering secret questions and or providing the card verification value (CVV) number, etc. may be utilized to verify the identity of the user as the cardholder. The card may be mapped to the user's account only upon successful verification of the user's identity.

In one embodiment, the user selection of the button 514 is indicative of the completion of the addition of the payment cards to be mapped to the user account. Subsequent to the selection of the button 514, the user may be provisioned a UI requesting the user to provide a biometric input to associate the corresponding biometric information with the user account. Such a UI is explained with reference to FIG. 6.

FIG. 6 is a simplified representation of a UI 600 facilitating association of user biometric information with a user account created on the payment network 200 (shown in FIG. 2), in accordance with one embodiment of the present invention.

The UI 600 may be displayed on a display screen of the customer's electronic device subsequent to the selection of the button 514 on the UI 500. As explained above, the user may connect with the computer system 204 of the payment network 200 and create a user account. The processor 302 may be configured to provision a UI, such as the UI 500 for facilitating mapping of the payment cards to the user account. Subsequent to the completion of the mapping of the payment cards, the user may be provisioned the UI 600 for associating user biometric information with the user account. The UI 600 depicts a message 602 including text ‘Please scan your fingerprint’. In one embodiment, the user may provision a thumb impression on a fingerprint scanner (for example, on a power key of the electronic device embodied as a mobile phone or a fingerprint scanner device in an ATM or a POS terminal) to provision the fingerprint scan input. Indeed other forms of biometric input, such as iris scan input and the like, which are capable of uniquely identifying the user may also be requested as biometric information from the user. The processor 302 may be configured to receive the fingerprint scan input provided by the user and record the biometric information in the database 206. It is noted that several users (or cardholders as interchangeably referred to herein) may create a user account with the computer system 204 of the server system 202 and map payment cards and biometric information with their respective user account. The computer system 204 may be configured to store user account information in the database 206.

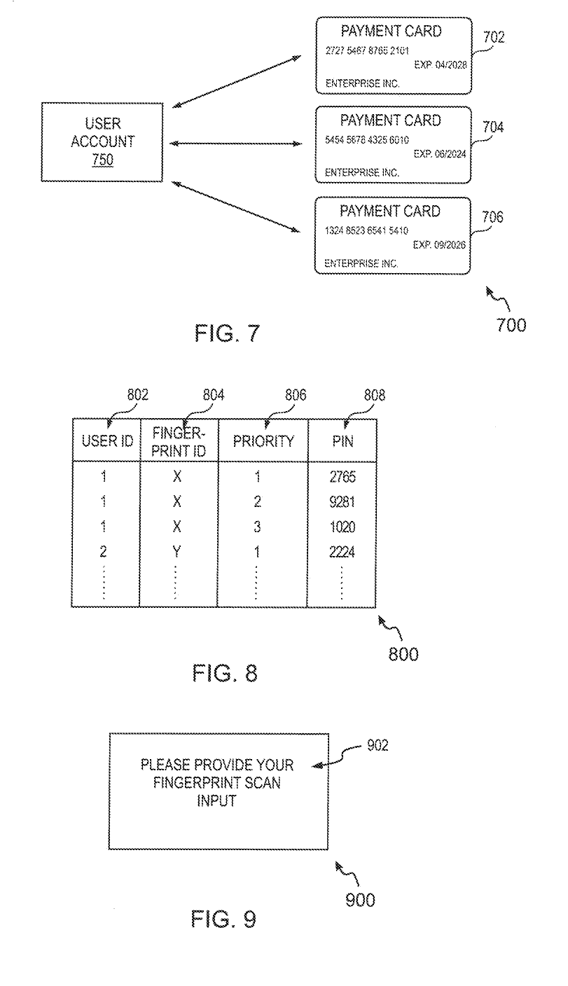

FIG. 7 is a schematic representation 700 of a user account linked to multiple payment cards, in accordance with one embodiment of the present invention. As explained with reference to FIG. 5, the payment network 200 enables a user (or a cardholder) to create a user account and map multiple payment cards to the user account. The mapping of the payment cards to the user account may be configured to link the payments cards with the user account (i.e. with the user). The schematic representation 700 depicts an example scenario where a user has mapped three payment cards, such as payment card 702, payment card 704 and payment card 706 to a user account 750. The information corresponding to the card number, PIN and the priority rank for each payment card linked with the user account 750 are stored in the database 206. An example format of storage of information related to the linked payment cards is shown in FIG. 8.

FIG. 8 is a simplified representation of a format 800 for storing payment card information related to several user accounts, in accordance with one embodiment of the present invention. As explained above, the database 206 of the server system 202 is configured to store a plurality of user accounts. Each user account includes biometric information capable of uniquely identifying respective user and information related to one or more payment cards associated with the respective user. The stored information corresponding to the plurality of user accounts may be maintained using a format, such as the format 800.

The format 800 is depicted to include four columns 802, 804, 806 and 808. The column 802 is associated with a header ‘User ID’ and includes information related to user ID number, exemplarily depicted to be ‘1’ for a first user, ‘2’ for second user and so on and so forth. In some embodiments, the column 802 may include information related to user account numbers instead of user ID numbers. The column 804 is associated with a header ‘Fingerprint ID’ and includes information related to fingerprint ID numbers for users. The fingerprint scan input provided by each user may be stored in the database 206 along with a unique ID, referred to herein as the fingerprint ID. The fingerprint ID for the first user is exemplarily depicted to be ‘X’, whereas the fingerprint ID for the second user is exemplarily depicted to be ‘Y’.

The column 806 is associated with a header ‘Priority’ and includes information related to priority ranks assigned for each payment card associated with the respective users. The first user is depicted to have three payment cards linked with the respective user account and accordingly, the priority ranks are depicted to be ‘1’, ‘2’ and ‘3’. The column 808 is associated with a header PIN′ and includes information related to personal identification number or PIN that the user typically punches at the POS terminal/ATM for each payment card. The PIN for the payment card of the first user with priority ‘1’ is exemplarily depicted to be ‘2765’, for the payment card with priority ‘2’ is exemplarily depicted to be ‘9281’, and for the payment card with priority ‘3’ is exemplarily depicted to be ‘1020’. Similarly, the PIN for the payment card of the second user with priority ‘1’ is exemplarily depicted to be ‘2224’. It is noted that the format 800 is explained herein for illustration purpose and may not be considered to be limiting the scope of the present invention. Indeed various other formats for storing linked card information in the database 206 may be contemplated.

The user account linked with the payment cards and the biometric information may facilitate financial transactions, while precluding the need for the user to carry multiple payment cards, as will be explained hereinafter.

FIG. 9 is a simplified representation of a first UI 900 presented to a user for initiating a financial transaction, in accordance with one embodiment of the present invention. In one embodiment, the first UI 900 may be displayed to the user on a display screen of an electronic device embodied as a POS terminal. As explained with reference to FIG. 4, the display module 408 may cause display of the first UI 900 (hereinafter referred to as UI 900) on the display screen of the electronic device. In one embodiment, the UI 900 may be displayed to the user on a display screen of an electronic device embodied as an ATM. In one embodiment, the UI 1000 may be displayed to the user on a display screen of an electronic device embodied as a personal computing device subsequent to the user initiating an online purchase transaction.

The UI 900 is depicted to display a message 902 including text ‘Please provide your fingerprint scan input’ to request biometric information, capable of uniquely identifying the user. In at least some embodiments, the electronic device embodied as the POS terminal, the ATM or the personal computing device may be capable of receiving a fingerprint scan. More specifically, the electronic device may include necessary hardware/firmware for recording user biometric information. In response to the message 902, the user may provide the fingerprint scan input as provided earlier for associating biometric information with the user account.

In one embodiment, the electronic device upon receiving the fingerprint scan input from the user is configured to communicate the input to the server system 202. The input (in form of biometric scan input) may be communicated for example by using a communication module, such as the communication module 412 depicted in FIG. 4. In one embodiment, the communication interface 306 of the computer system 204 (depicted in FIG. 3) may be configured to receive the fingerprint scan input and provision the fingerprint scan input to the processor 302. In at least one example embodiment, the processor 302 may be configured to match the fingerprint scan input with stored biometric information for a plurality of users to uniquely identify the user and obtain the fingerprint ID. If the input matches with a stored fingerprint ID, then the user may be deemed to be successfully identified.

In one embodiment, the processor 302, subsequent to successfully identifying the user, may be configured to retrieve information related to one or more payment cards linked with the user. Each payment card, as explained above, is associated with a banking account with an issuer bank and is capable of facilitating financial transactions. The processor 302 may be configured to use the fingerprint ID to retrieve the one or more payment cards linked with the user account (or in other words, linked with the user) from a stored format, such as the format 800 explained with reference to FIG. 8.

In one embodiment, subsequent to the successful identification of the user and the retrieval of the linked payment cards, the processor 302 may be configured to cause display of a prompt on the electronic device for selection of a payment card from among the one or more linked payment cards for executing the financial transaction. The prompt may be provisioned to the user on the display screen of the electronic device in various manners, as will be explained next with reference to FIGS. 10 to 12.

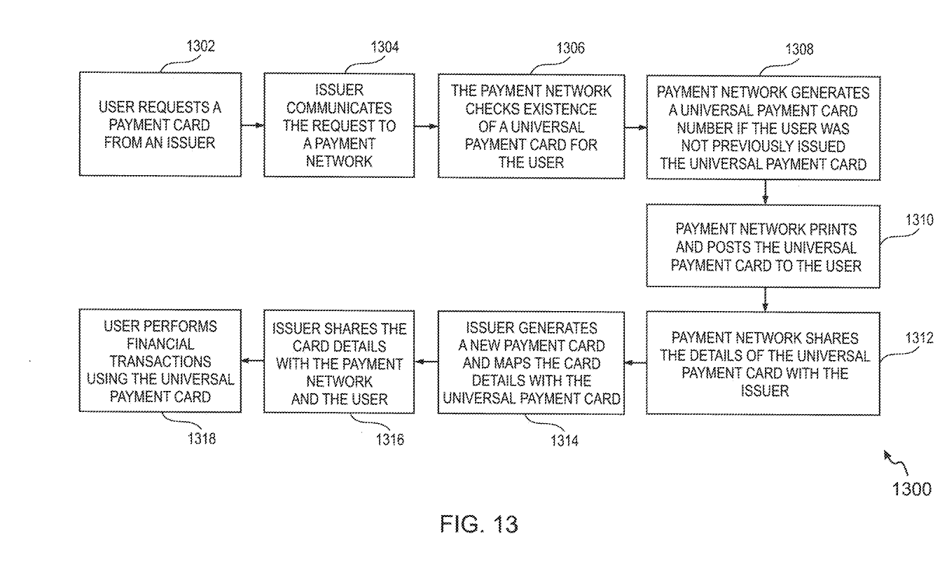

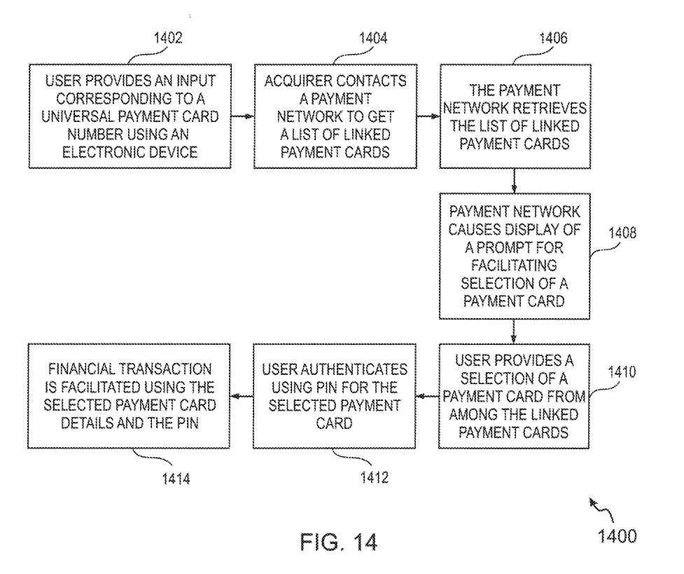

It is noted that in some embodiments, in addition to requesting the fingerprint scan input from the user, the electronic device may be configured to also request a unique identification number. As explained with reference to FIG. 5, the user may provide a unique identification number (such as the social security number, PAN, etc.) as part of the user account creation process. In one embodiment, the unique identification number may be a ‘universal payment card number’. The provisioning of the ‘universal payment card number’ for retrieving payment cards linked to the user account is explained in detail with reference to FIGS. 13 and 14. The provisioning of the unique identification number along with the fingerprint scan input may enable the processor 302 to preclude search for a matching the fingerprint scan input among the stored records in the database 206. Instead, the processor 302 may directly identify the user account using the unique identification number, retrieve the fingerprint ID stored in the user account, match the fingerprint scan input to the stored fingerprint scan associated with the fingerprint ID to identify the user and retrieve the payment cards linked to the user account.

FIG. 10 is a simplified representation of a second UI 1000 displaying a prompt 1002 to the user to select a payment card for executing the financial transaction, in accordance with one embodiment of the present invention. As explained above, the user may provide a biometric input to authenticate a personal identity for initiating a financial transaction. The input may be provided by the user using an electronic device. Further, as explained above, the electronic device may correspond to a personal computing device of the user, a POS terminal at a merchant site or an ATM. The biometric input may be used to identify a user identity and retrieve one or more payment cards linked with the user account. Upon retrieval of the one or more cards linked with the user, the processor 302 may be configured to cause display of a prompt on the electronic device for selection of a payment card from among the one or more linked payment cards for executing the financial transaction. More specifically, the processor 302 may be configured to cause display of the UI 1000 showing a prompt 1002 including text ‘Please select a payment card for the transaction’. It is noted that the text associated with the prompt 1002 is shown herein for illustration purposes and may not be considered to be limiting the scope of the present invention. Indeed various other formats of the prompt requesting the user to select a payment card may be contemplated.

In an example embodiment, the user may provide the selection of the payment card by providing the priority rank of the payment card to be used for the financial transaction and a PIN associated with the card. For example, if the user intends to use the payment card associated with the priority rank ‘2’ and the payment card is associated with a PIN ‘9281’, then the user may input ‘29281’ to indicate a selection of the payment card with priority rank 2 for executing the financial transaction as exemplarily depicted by the user selection input 1004. In at least one example embodiment, the processor 302 may be configured to receive the user selection of the payment card from the electronic device. The processor 302 may be configured to parse the user selection input to retrieve the priority rank of the payment card and the PIN of the payment card. The processor 302 may be configured to identify the payment card that the user intends to use for the current transaction based on the priority rank. More specifically, the payment card assigned with the priority rank ‘2’ may be selected as the payment card for executing the financial transaction. The processor 302 may further be configured to compare the PIN with the stored PIN for the selected payment card. If the PIN matches with the stored entry, then the processing of the financial transaction may be facilitated by the processor 302. The term ‘facilitating the processing of the financial transaction’ as used herein refers to the steps of sending the card details to the card issuing entity (i.e. the issuer) to ascertain whether the user's banking account is in good standing and whether the financial transaction is covered by the user's available credit line or account balance. Based on these determinations, a request for authorizing the financial transaction may be declined or accepted. If the request is accepted, an authorization code is issued to merchant (i.e. intended recipient of the financial transaction). When a request for authorization is accepted, the available credit line or available balance of user's banking account is decreased. Such processing of the financial transaction may be performed as explained with reference to FIG. 1 and is not explained again herein.

In some scenarios, the PIN retrieved from parsing the user selection input may not match the stored entry corresponding to the selected card. In such a scenario, an error message may be displayed to the user and the user may be requested to retry the payment card selection input. In some embodiments, the prompt 1002 displayed to the user may be associated with images of the linked cards. Such a scenario is explained with reference to FIG. 11.

FIG. 11 is a simplified representation of a second UI 1100 displaying a prompt 1102 to the user to select a payment card for executing the financial transaction, in accordance with another embodiment of the present invention. The processor 302 may be configured to cause display of the second UI 1100 (hereinafter referred to as UI 1100) showing a prompt 1102 including text ‘Please select a payment card for the transaction’ in response to successful authentication of the personal identity of the user by way of matching biometric input. The biometric input may be used to identify a user identity and retrieve one or more payment cards linked with the user account. Upon retrieval of the one or more payment cards linked with the user, the processor 302 may be configured to cause display of the prompt 1102 on the electronic device for selection of a payment card from among the one or more linked payment cards for executing the financial transaction. Additionally, the processor 302 may be configured to display images of the linked payment cards, such as images 1104, 1106 and 1108 corresponding to the linked payment card 1, payment card 2 and payment card 3, respectively.

In an illustrative example, a user may intend to withdraw currency at an ATM kiosk. The user may provide a biometric input at a biometric scanner associated with the ATM kiosk. The display screen of the ATM kiosk may then be configured to display an UI, such as the UI 1100, showing a prompt and images of linked cards, requesting the user to select a payment card associated with a banking account, from which the user wishes to withdraw currency.

In one embodiment, the user may provide a click or a touch input on the image of a payment card to provide the selection of the payment card for the financial transaction. In one embodiment, subsequent to receiving the user selection of the payment card, the user may be requested to provision the PIN for the selected payment card. The PIN provided by the user may be matched to the stored PIN entry for the selected payment card by the processor 302. If the PIN matches with the stored entry in the user account, the processing of the financial transaction may be facilitated as explained with reference to FIG. 10. In some embodiments, the provisioning of the PIN may be precluded, and instead, the user may be authenticated using the biometric input as authenticated earlier. In some embodiments, the user may be requested to provide the unique identification number along with the biometric input subsequent to receiving the user selection of the payment card. The provisioning of the unique identification number along with biometric input may reduce a processing time and further, render a more robust security mechanism for user authentication.

In one embodiment, the processor 302 may be configured to cause display of details of the payment cards linked with the user account in an encrypted form. For example, the processor 302 may cause display of a string of characters (for example, a combination of alphabets, numbers, special characters, and the like) for each payment card linked with the user account on a display screen of the electronic device to facilitate the user selection of the card. The string of characters may be displayed along with the prompt seeking selection of the payment card from the user. Such a scenario is depicted in FIG. 12.

FIG. 12 is a simplified representation of a second UI 1200 displaying a prompt 1202 to the user to select a payment card for executing the financial transaction, in accordance with yet another embodiment of the present invention. Upon retrieval of the one or more payment cards linked with the user, the processor 302 may be configured to display the prompt 1202 on the electronic device for selection of a payment card from among the linked payment cards for executing the financial transaction. For example, if the user account is linked with a Citibank® credit card, a Citibank® debit card and an American Express® corporate card, then the processor 302 may cause display of string of characters for these cards using string of characters 1204, 1206 and 1208, respectively.

In one embodiment, the user may provide a click or a touch input on the string of characters corresponding to a payment card to provide the selection of the payment card for the transaction. In one embodiment, subsequent to receiving the user selection of the payment card, the user may be requested to provision the PIN for the selected payment card. The PIN provided by the user may be matched to the stored PIN entry for the selected card by the processor 302. If the PIN matches with the stored entry in the user account, the processing of the financial transaction may be facilitated.

As explained above, in some embodiments, the user may provide a unique identification number such as a social security number, a PAN or a universal payment card number in addition to the biometric input (or in some cases without the biometric input) to cause the processor 302 to retrieve the one or more payment cards linked with the user account. The issuing of a universal payment card to a user by the payment network 200 is explained with reference to FIG. 13.

FIG. 13 is a simplified representation of an example process flow 1300 for issuing a universal payment card to the user, in accordance with one embodiment of the present invention.

In one embodiment, a user wishing to procure a payment card may request an issuer (for example, a bank) for a payment card, such as debit card or a credit card. The issuer is referred to herein as a first card issuing entity for purposes of simplicity. The first card issuing entity may communicate the request for a payment card to the server system 202 of the payment network 200. The processor 302 of the computer system 204 within the server system 202 may receive the request for issuing a payment card to the user. In response to the request, the processor 302 may first check if the user was previously issued a universal payment card or not. If the user was not issued a universal payment card previously, then the processor 302 may be configured to generate a unique identification number and cause printing and posting of a payment card with the unique identification number to the user. The payment card generated with the unique identification number may serve as the ‘universal payment card’ and the number may serve as the universal payment card number.

In one embodiment, the universal payment card may be associated with a 16-digit card number printed on it with issue date, expiry date and CVV number. In some embodiments, the universal payment card may be associated with a new brand logo so as to differentiate the universal payment card from other credit/debit/banking cards. In an embodiment, the new brand logo may be acceptable by all the payment networks (Mastercard®, Visa®, Euro® etc.).

In one embodiment, the processor 302 may be configured to share the information such as the universal payment card number, PIN, CVV number with the first card issuing entity. In one embodiment, the first card issuing entity may generate a new banking card (for example, a credit\debit card) for the user and map all the details with the universal payment card in the respective banking system. In one embodiment, the first card issuing entity generated banking card details may be shared with the user, for example, via email.

In a scenario, when the user requests a new payment card from the same card issuing entity or a different issuer (for example, second card issuing entity), the issuer may generate a new banking card and map all the details with the universal payment card in their respective system. The issuer may then share the new banking card details via email with user. Such issuance of a universal payment card may remove the requirement of physically creating and issuing a new payment card each time a user requests a new payment card, and furthermore, may also remove the requirement to print\post\track the new payment card each time a new payment card is sanctioned to the user. Furthermore, the user may now carry a single universal payment card instead of carrying multiple payment cards issued by various card issuing entities. A process flow 1300 for issuing a universal payment card to a user is explained in detail below. The process flow 1300 starts at 1302.

At 1302 of the process flow 1300, a user requests a payment card from an issuer (for example, the first card issuing entity). At 1304, the issuer communicates the request to a payment network, such as the payment network 200. At 1306, the payment network checks for an existence of a universal payment card for the user. If the user is not associated with a universal payment card, then at 1308, a universal payment card number is generated for the user by the payment network.

At 1310, the universal payment card is printed and posted to the user by the payment network. It is noted that the universal payment card is posted only once to the user. At 1312, the payment network shares the details (for example, card number, expiry date, CVV number) with the issuer. At 1314, the issuer generates a new payment card (for example, a credit/debit card) and maps the details of the universal payment card with the new payment card to link the new payment card with the universal payment card.

At 1316, the issuer shares the new payment card details with the payment network and the user. In one embodiment, the issuer may share the payment card details with the user over email. At 1318, the user performs financial transactions using the universal payment card. For example, the user may use the universal payment card at financial transaction sites, such as at the merchant sites, Websites, ATM kiosks, and the like, to retrieve the individual banking cards linked with the universal payment card and execute the financial transactions. The process flow 1300 ends at 1318. The execution of the financial transaction using the universal payment card is explained with reference to FIG. 14.

FIG. 14 is a simplified representation of an example process flow 1400 for executing a financial transaction using a universal payment card, in accordance with one embodiment of the present invention. The process flow 1400 starts at 1402.

At 1402, a user provides an input corresponding to a universal payment card number using an electronic device. It is noted that in some embodiments, the user may physically key-in the digits of the universal payment card number, whereas in some scenarios, the user may insert the universal payment card to provide the input. Such an input may be provided to initiate a financial transaction at a transaction site.

At 1404, the acquirer (i.e. the electronic device) is configured to provision the universal payment card details to the acquirer (or the acquiring bank), which may in turn provision the universal payment card details to a payment network, such as the payment network 200, to get a list of payment cards linked with the universal payment card. As explained with reference to FIG. 13, the user is issued a universal payment card by the payment network and all payment cards from one or more issuers are linked with the universal payment card.

At 1406, the payment network retrieves the list of linked payment cards (i.e. card details issued by various issuers and linked with the universal payment card).

At 1408, the payment network causes display of a prompt for facilitating selection of a payment card. The provisioning of the prompt for selection of the payment card may be performed as explained with reference to FIGS. 10, 11 and 12 and is not explained herein.

At 1410, the user provides a selection of a payment card from among the linked payment cards.

At 1412, the user provides a PIN for the chosen payment card to authenticate a personal identity. At 1414, processing of the financial transaction is facilitated using the selected payment card and the PIN. The process flow 1400 ends at 1414.

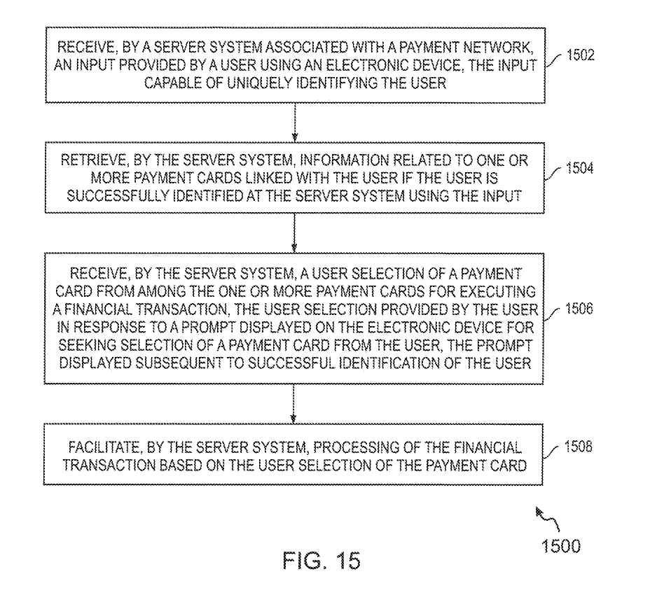

FIG. 15 is a flow diagram of an example method 1500 for facilitating a payment card based financial transaction, in accordance with one embodiment of the present invention. The method 1500 depicted in the flow diagram may be executed by, for example, the server system 202 explained with reference to FIG. 2. Operations of the flowchart, and combinations of operation in the flowchart, may be implemented by, for example, hardware, firmware, a processor, circuitry and/or a different device associated with the execution of software that includes one or more computer program instructions. The operations of the method 1500 are described herein with help of the server system 202. It is noted that the operations of the method 1500 can be described and/or practiced by using a system other than the server system 202. The method 1500 starts at operation 1502.

At operation 1502, an input provided by a user using an electronic device is received by a server system associated with a payment network. The input is capable of uniquely identifying the user. In an embodiment, the input is a biometric input corresponding to at least one of a finger scan input and an iris scan input. Some non-limiting examples of the electronic device may include an automated teller machine (ATM), a POS merchant device and a personal computing device of the user, and the like. The input may be provided by the user to initiate a financial transaction. Some non-exhaustive examples of financial transaction may include a currency withdrawal transaction at an automated teller machine (ATM) kiosk, a point-of-sale (POS) transaction at a merchant site, an online transaction on a Website, and the like.

At operation 1504, information related to one or more payment cards linked with the user is retrieved by the server system if the user is successfully identified at the server system using the input. In one embodiment, the user may create a user account with the server system and map one or more payment cards (such as for example, debit cards, credit cards, other banking cards, etc.) with the user account. Each payment card from among the one or more payment cards is capable of facilitating financial transactions. The user may also link biometric input with the user input. The biometric input provided by the user may be compared with stored user account information to identify the user. The mapped payment cards with the user account may then be fetched by the server system.

At operation 1506, a user selection of a payment card from among the one or more payment cards for executing a financial transaction is received by the server system. In one embodiment, subsequent to successful identification of the user and the retrieval of the linked payment cards, user may be displayed a prompt seeking selection of a payment card from among the linked payment cards for continuing with the transaction.

In one embodiment, the prompt may be associated with display of encrypted form of the details of the linked payment cards so as to facilitate selection of a payment card. In one embodiment, the user may provide an input corresponding to a priority rank of the payment card (stored in the user account) along with the PIN of the card to provide selection of the payment card. The user selection input may be facilitated as explained with reference to FIGS. 10 to 12. At operation 1508, processing of the financial transaction is facilitated by the server system based on the user selection of the payment card.

The method 1500 ends at 1508.

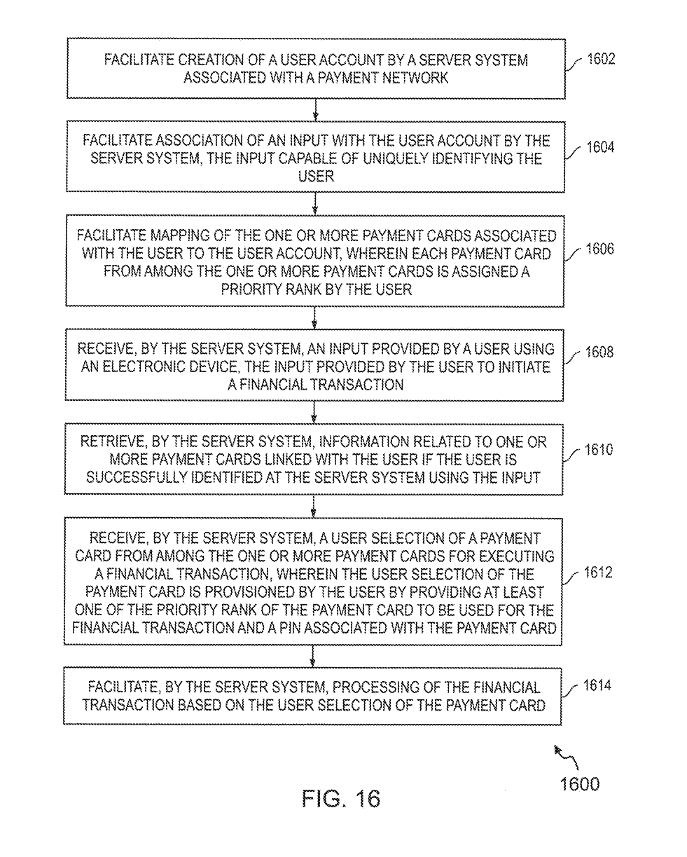

FIG. 16 is a flow diagram of an example method 1600 for facilitating a financial transaction using a payment card, in accordance with one embodiment of the present invention. The method 1600 depicted in the flow diagram may be executed by, for example, the server system 202 explained with reference to FIG. 2. The method 1600 starts at operation 1602.

At operation 1602, creation of a user account is facilitated by a server system associated with a payment network. The creation of the user account may be performed as explained with reference to FIG. 4.

At operation 1604, an association of an input with the user account is facilitated by a server system. The input is capable of uniquely identifying the user. In an embodiment, the input is a biometric input corresponding to at least one of a finger scan input and an iris scan input.

At operation 1606, mapping of the one or more payment cards associated with the user to the user account is facilitated. The mapping of the one or more payment cards is configured to link the one or more payment cards with the user. Each payment card from among the one or more payment cards is assigned a priority rank by the user. The mapping of the payment cards may be performed as explained with reference to FIG. 5.

At operation 1608, an input provided by a user using an electronic device is received by the server system. The input is provided by the user to initiate a financial transaction. Some non-exhaustive examples of financial transaction may include a currency withdrawal transaction at an automated teller machine (ATM) kiosk, a point-of-sale (POS) transaction at a merchant site, an online transaction on a Website, and the like. Some non-limiting examples of the electronic device may include an automated teller machine (ATM), a POS merchant device and a personal computing device of the user, and the like.

At operation 1610, information related to one or more payment cards linked with the user is retrieved by the server system if the user is successfully identified at the server system using the input.

At operation 1612, a user selection of a payment card from among the one or more payment cards for executing a financial transaction is received by the server system. The user selection of the payment card is provisioned by the user by providing at least one of the priority rank of the payment card to be used for the financial transaction and a PIN associated with the payment card.

At operation 1614, processing of the financial transaction is facilitated by the server system based on the user selection of the payment card. The method 1600 ends at operation 1614.

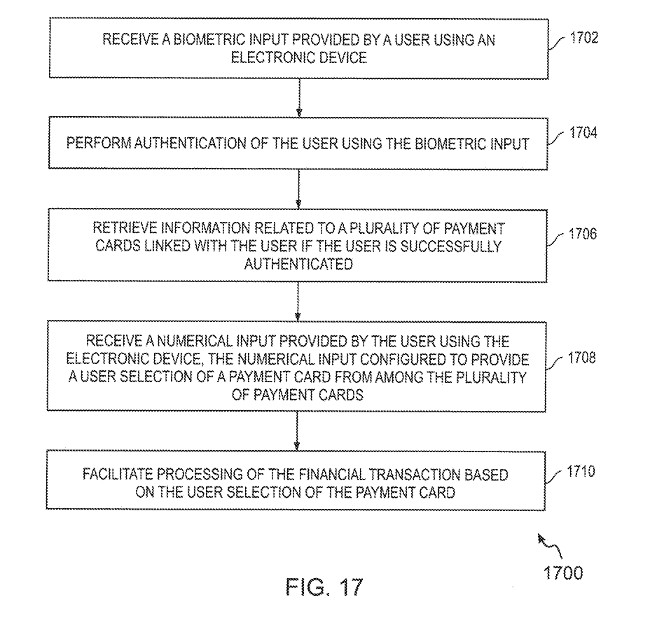

FIG. 17 is a flow diagram of an example method 1700 for facilitating a financial transaction using a payment card, in accordance with one embodiment of the present invention. One or more operations of the method 1700 depicted in the flow diagram may be executed by, for example, the server system 202 explained with reference to FIG. 2. The method 1700 starts at operation 1702.

At operation 1702, a biometric input provided by a user using an electronic device is received. In an embodiment, the biometric input corresponds to at least one of a finger scan input and an iris scan input. Some non-limiting examples of the electronic device may include an automated teller machine (ATM), a POS merchant device and a personal computing device of the user, and the like. The input may be provided by the user to initiate a financial transaction. Some non-exhaustive examples of financial transaction may include a currency withdrawal transaction at an automated teller machine (ATM) kiosk, a point-of-sale (POS) transaction at a merchant site, an online transaction on a Website, and the like.

In one embodiment, the input may be received by a server system associated with a payment network, such as the MasterCard® interchange network explained with reference to FIGS. 1 to 4. In one embodiment, an exposed application programming interface (API) of a payment gateway may receive the biometric input provisioned by the user using the electronic device. The API may be configured to provision the biometric input to a private or governmental agency, which maintains a database of user biometric inputs and which is capable of facilitating user authentication.

At operation 1704, an authentication of the user is performed using the biometric input. The biometric input provided by the user using the electronic device may be compared with entries in the database of biometric inputs for a match. The user may be authenticated if the biometric input matches an entry in the database of stored biometric inputs. In at least some embodiments, the user may be identified based on the successful authentication of the user's biometric input.

If the user is successfully authenticated at operation 1704, then at operation 1706, information related to a plurality of payment cards linked with the user is retrieved. In one embodiment, the user may create a user account with a payment network and map a plurality of payment cards (such as for example, debit cards, credit cards, other banking cards, etc.) with the user account. The mapping of the payment cards may be performed as explained with reference to FIG. 5. Each payment card is capable of facilitating financial transactions. The user may also link biometric input with the user input. Each payment card may also be assigned a priority rank by the user. The biometric input provided by the user may be compared with stored user account information to identify the user. The mapped payment cards with the user account may then be retrieved subsequent to the successful authentication of the user.

At operation 1708, a numerical input provided by the user using the electronic device is received. In one embodiment, subsequent to successful authentication of the user and the retrieval of the linked payment cards, user may be displayed a prompt seeking selection of a payment card from among the linked payment cards for continuing with the transaction. In response to the displayed prompt, the user may provide the numerical input. The numerical input is configured to provide a user selection of a payment card from among the plurality of payment cards. In one embodiment, the numerical input may include the priority rank assigned by the user to the payment card at the time of mapping of the payment cards to the user account. For example, if a payment card was assigned a priority rank of ‘1’ at the time of mapping the payment card to the user account (i.e. if the payment card was pre-assigned a priority rank of one), then the user may provide a numerical input of ‘1’ in response to the displayed prompt to provide selection of the payment card with pre-assigned priority rank of ‘1’. In some embodiments, the user may also provide a PIN number of the card along with priority rank to provide the user selection of the payment card. The provisioning of such a numerical input is explained with reference to FIG. 10 and is not explained again herein.

At operation 1710, processing of the financial transaction based on the user selection of the payment card is facilitated. More specifically, the financial transaction is executed using the payment card selected by the user by providing the numerical input.

The method 1700 ends at operation 1710.

The disclosed methods 1500, 1600 and 1700 or one or more operations of the methods 1500, 1600 and 1700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Various example embodiments offer, among other benefits, techniques for efficiently facilitating financial transactions using payment cards. The methods and systems disclosed herein enable processing of the financial transactions, while precluding the users from physically carrying multiple payment cards. Moreover, the techniques disclosed herein provide the user with the convenience of using any card issued to the user for performing a financial transaction, while precluding the users from carrying multiple payment cards. Some embodiments disclose provisioning of a universal payment card to the user. Such issuance of a universal payment card may remove the requirement of physically printing and posting a new payment card each time a user requests a new payment card from an issuer. Furthermore, the user may be precluded from physically carrying multiple cards and instead carry a single universal payment card.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 202 and its various components such as the computer system 204 and the database 206 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIGS. 15, 16 and 17). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a server system associated with a payment network, an input provided by a user using an electronic device, the input capable of uniquely identifying the user;
if the user is successfully identified at the server system using the input, retrieving information related to one or more payment cards linked with the user by the server system, each payment card from among the one or more payment cards capable of facilitating at least one financial transaction;
receiving, by the server system, a user selection of a payment card from among the one or more payment cards for executing a financial transaction, the user selection provided by the user in response to a prompt displayed on the electronic device for seeking selection of a payment card from the user, the prompt displayed subsequent to successful identification of the user; and
facilitating, by the server system, processing of the financial transaction based on the user selection of the payment card.

2. The method as claimed in claim 1, further comprising facilitating by the server system:
creation of a user account with the payment network by the user;
association of the input with the user account by the user; and
mapping of the one or more payment cards associated with the user to the user account, the mapping of the one or more payment cards configured to link the one or more payment cards with the user.

3. The method as claimed in claim 1, further comprising:
receiving, by the server system, a priority rank for each payment card from among the one or more payment cards from the user, wherein the priority rank is configured to facilitate selection of the respective payment card for processing financial transactions.

4. The method as claimed in claim 3, wherein the user selection of the payment card is provisioned by the user by providing at least one of the priority rank of the payment card to be used for the financial transaction and a PIN associated with the payment card.

5. The method as claimed in claim 1, further comprising:
causing display of an image of each payment card from among the one or more payment cards on the electronic device to facilitate the user selection of the payment card, wherein the one or more payment cards are displayed along with the prompt seeking selection of the payment card from the user.

6. The method as claimed in claim 1, further comprising:
causing display of a string of characters representing each payment card from among the one or more payment cards on the electronic device to facilitate the user selection of the payment card, wherein the string of characters are displayed along with the prompt seeking selection of the payment card from the user.

7. The method as claimed in claim 1, wherein the input is a biometric input corresponding to at least one of a finger scan input and an iris scan input.

8. The method as claimed in claim 1, wherein the input is a unique identification number associated with the user.

9. The method as claimed in claim 1, further comprising:
receiving, by the server system, communication from a first card issuing entity, the communication corresponding to a request for procuring a payment card from the user to the first card issuing entity;
issuing, by the server system, a universal payment card to the user, the universal payment card associated with a unique universal payment card number, wherein the first card issuing entity is configured to link the universal payment card to a payment card issued to the user by the first card issuing entity in response to the user request, wherein each subsequent payment card issued to the user by one or more card issuing entities is linked to the universal payment card.

10. The method as claimed in claim 9, wherein the input comprises the universal payment card number and, wherein the user is prompted to select a payment card from among the one or more payment cards linked to the universal payment card for processing the financial transaction.

11. A server system associated with a payment network, the server system comprising:
a database configured to store a plurality of user accounts, each user account comprising information related to user input capable of uniquely identifying respective user, and information related to one or more payment cards associated with the respective user, each payment card from among the one or more payment cards capable of facilitating at least one financial transaction; and
a computer system in operative communication with the database, the computer system comprising:
a communication interface configured to receive an input provided by a user, the input provisioned by the user using an electronic device for initiating a financial transaction, the input capable of uniquely identifying the user; and
a processor in operative communication with the communication interface, the processor configured to:
compare the input provided by the user with stored information corresponding to the plurality of user accounts to identify the user;
if the user is successfully identified using the input, retrieve information related to one or more payment cards linked with the user;
receive a user selection of a payment card from among the one or more payment cards for executing the financial transaction, wherein the user selection is provided by the user in response to a prompt displayed on the electronic device for seeking selection of a payment card from the user, the prompt displayed subsequent to successful identification of the user; and
facilitate processing of the financial transaction based on the user selection of the payment card.

12. The server system as claimed in claim 11, wherein the processor is further configured to facilitate:
creation of a user account with the payment network by the user;
association of the input with the user account by the user; and
mapping of the one or more payment cards associated with the user to the user account, the mapping of the one or more payment cards configured to link the one or more payment cards with the user.

13. The server system as claimed in claim 11, wherein the communication interface is further configured to:
receive a priority rank for each payment card from among the one or more payment cards from the user, wherein the priority rank is configured to facilitate selection of the respective payment card for processing financial transactions, and wherein the user selection of the payment card is provisioned by the user by providing at least one of the priority rank of the payment card to be used for the financial transaction and a PIN associated with the payment card.

14. The server system as claimed in claim 11, wherein the processor is further configured to cause display of one of:
an image of each payment card from among the one or more payment cards on the electronic device to facilitate the user selection of the payment card, wherein the one or more payment cards are displayed along with the prompt seeking selection of the payment card from the user; and
a string of characters representing each payment card from among the one or more payment cards on the electronic device to facilitate the user selection of the payment card, wherein the string of characters are displayed along with the prompt seeking selection of the payment card from the user.

15. The server system as claimed in claim 11, wherein the input is a biometric input corresponding to at least one of a finger scan input and an iris scan input.

16. The server system as claimed in claim 11, wherein the server system is further configured to:
receive communication from a first card issuing entity, the communication corresponding to a request for procuring a payment card from the user to the first card issuing entity; and
issue an unique universal payment card to the user, the universal payment card associated with an unique universal payment card number, wherein the first card issuing entity is configured to link the universal payment card to a payment card issued to the user by the first card issuing entity in response to the user request, wherein each subsequent payment card issued to the user by one or more card issuing entities is linked to the universal payment card.

17. The server system as claimed in claim 16, wherein the input comprises the universal payment card number and, wherein the user is prompted to select a payment card from among the one or more payment cards linked to the universal payment card for processing the financial transaction.

18. A computer-implemented method, comprising:
receiving a biometric input provided by a user using an electronic device;
performing authentication of the user using the biometric input;
if the user is successfully authenticated, retrieving information related to a plurality of payment cards linked with the user, each payment card from among the plurality of payment cards capable of facilitating at least one financial transaction;
receiving a numerical input provided by the user using the electronic device, the numerical input configured to provide a user selection of a payment card from among the plurality of payment cards; and
facilitating processing of the financial transaction based on the user selection of the payment card.

19. The method as claimed in claim 18, wherein the numerical input comprises a priority rank of the payment card, wherein each payment card from among the plurality of payment cards is pre-assigned a respective priority rank by the user to facilitate selection of the respective payment card for processing financial transactions.

20. The method as claimed in claim 18, further comprising facilitating:
creation of a user account with a payment network by the user;
association of the biometric input with the user account by the user; and
mapping of the plurality of payment cards associated with the user to the user account, the mapping of the plurality of payment cards configured to link the plurality of payment cards with the user.
